(19) United States
(12) Patent Application Publication
(10) Pub. No.: US 2007/0022619 A1
(43) Pub. Date: Feb. 1, 2007

(54) Tool damage detection device

(75) Inventor: Akira Matsuhashi, Tachikawa-shi (JP)

Correspondence Address: KANESAKA BERNER AND PARTNERS LLP, 1700 DIAGONAL RD, SUITE 310, ALEXANDRIA, VA, 22314-2848, US

(73) Assignee: METOROL CO., LTD., Tachikawa-shi (JP)

(21) Appl. No.: 11/327,480

(22) Filed: Jan. 9, 2006

(30) Foreign Application Priority Data
Jul. 29, 2005 (JP) 2005-221749

(51) Int. Cl. B23Q 17/22

(52) U.S. Cl. 33/628; 83/522.15

(57) ABSTRACT

A tool damage detection device includes a contact rod for abutting against a side face of a rotating tool piece at a right angle. The contact rod is a beltlike hardening leaf spring with a width capable of spanning a spiral flute in the rotating tool piece. In view of the contact rod width, the device can detect tool piece damage without falling into the rotating spiral flute. Thus, the contact rod is not scraped or bent, and consequently, the tool piece being monitored can continue to rotate. Therefore, the tool damage detection device can improve the operating rate of the tool.

### BACKGROUND OF THE INVENTION AND RELATED ART STATEMENT

The present invention relates to a tool damage detection device used to detect the presence or absence of damage (side or edge) of a tool such as a drill, tap, reamer, end mill, and so on.

Conventionally, for example, as shown in FIG. 4, in a tool damage detection device, a contact rod 44 consisting of a base end portion 43 fixed to a main axis 42 of a driving member 41 of a device main body is rotated in a certain range by operation of the driving member 41, and abutted against the side face of a tool 45 which resides within the range of the rotation at a right angle. When the contact rod 44 passes without abutting against the tool 45, the tool damage detection device assesses “damage,” and outputs a warning or stop signal to a machine control member (not shown in the figure) (Refer to Japanese Patent Publication No. 2001-038512 and Japanese Patent Publication No. 2005-198553).

However, as shown in FIG. 4, the contact rod 44 of the above-mentioned device is a wire needle with a small diameter so that it is not suited to be applied to the side face of a tool such as a rotating drill or tap from the right angle. This is because the contact rod 44 might fall into a groove of the tool such as the drill or tap with a spiral flute 45a for discharging a chip out of a hole during cutting, and be scraped, bent, or bounded. Therefore, when damages of the above-mentioned tools were detected, the rotation of the tool had to be stopped.

Also, in the above-mentioned prior art device, regardless of the rotation or stoppage of the tool, any damage that occurred on a lower side at a point where the contact rod 44 contacted could be detected. However, it was difficult to detect the damage (e.g., chipping) by abutting against a cut inclined face of the edge of the tool, because the contact rod sometimes escaped without abutting against the edge of the tool due to flexure or backlash and so on. In other words, although there was no chipping on the cut inclined face of the edge of the tool, the above-mentioned device might have assessed this as damage.

The present invention is made in order to solve the above-mentioned prior art problems. An object of the invention is to provide a tool damage detection device able to detect damage to the side part or edge of the tool.

Another object of the invention is to improve the operating rate of the machine that is being monitored. That is, the present invention detects damage without falling into the groove or blade of the rotating tool, and possibly being scraped, bent, or bounded, and thus, without stopping the rotation of the tool.

Still another object of the invention is to provide a tool damage detection device which does not misjudge the acceptability of the chipping amount of the cut inclined face of the edge of the tool being monitored.

Further objects and advantages of the invention will be apparent from the following description of the invention.

### SUMMARY OF INVENTION

In order to attain the above-described objects, a tool damage detection device according to the present invention detects damage by abutting a contact rod against the side face of a tool at a right angle. In one embodiment of the invention, the contact rod is a beltlike hardening leaf spring with a width capable of spanning a spiral flute such as that of a drill bit, so that the tool damage detection device can detect any damage while the tool is rotated.

In a device according to a second embodiment of the invention, the contact rod includes a wire needle, and a short beltlike hardening leaf spring. The leaf spring can be attached and removed in an intermediate part of the rod, or can be adjusted in position. The tool damage detection device can control the contact rod so as to not provide an excessive contact force to a thin tool. At the same time, the tool damage detection device can change the mounting orientation of the leaf spring in response to the rotational direction of the tool.

Moreover, according to a third embodiment of the invention, which also detects damage by abutting the contact rod against the side face of the tool at a right angle, the contact rod is a steel-plated rod whose cross-sectional surface is formed in an L shape. The contact rod avoids causing flexure in an axial direction on the edge side of the tool. A contact on the edge side of the L-shaped contact rod contacts a cut inclined face of the edge of the tool, so that damage to the edge of the tool can be easily detected.

According to the first embodiment of the invention, since the contact rod is a beltlike hardening leaf spring with a width capable of spanning a spiral flute such as that of a drill bit, the device can detect damage without falling into the spiral flute. Thus, the contact rod is not scraped or bent, and consequently, the tool being monitored can continue to rotate. Therefore, the tool damage detection device can improve the operating rate of the machine during detection.

Also, according to the second embodiment of the invention, the contact rod enables the short beltlike hardening leaf spring to assume a position on the intermediate part of the wire needle. Accordingly, the contact rod avoids applying excessive contact force to a thin tool. Also, since the short beltlike hardening leaf spring can be attached to and removed from the wire needle, various advantages can be attained. For example, the mounting orientation of the leaf spring can be freely adjusted in response to the rotational direction of the tool.

Moreover, according to the third embodiment of the invention, the contact rod is a steel-plated rod whose cross-sectional surface is L-shaped, and which does not cause flexure in the axial direction on the edge side of the tool. Also, the contact on the edge side of the L-shaped contact rod contacts the cut inclined face of the edge of the drill. As a result, an accurate determination of the acceptability of the chipping amount of the cut edge of the tool is possible.

### BRIEF DESCRIPTION OF THE DRAWINGS

FIGS. 1(a) and 1(b) show a device according to a first embodiment of the present invention, wherein FIG. 1(a) is a plan view of the device, and FIG. 1(b) is a front view.

FIGS. 2(a) and 2(b) show a device according to a second embodiment of the present invention, wherein FIG. 2(a) is a plan view of the device, and FIG. 2(b) is a front view.

FIGS. 3(a), 3(b), and 3(c) show a device according to a third embodiment of the present invention, wherein FIG. 3(a) is a plan view of the device, FIG. 3(b) is a front view, and FIG. 3(c) is an end view.

FIG. 4 is an explanatory perspective view showing a relationship between the rotation of a contact rod and a tool in a conventional device.

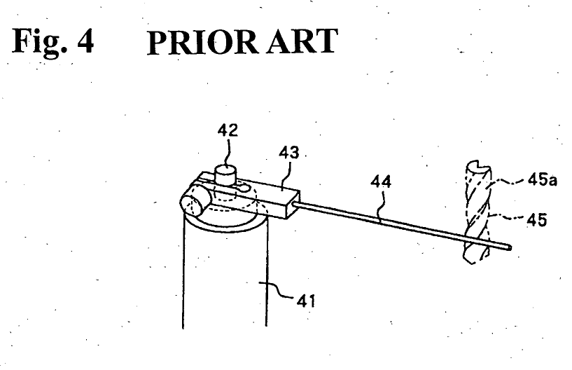

### DETAILED DESCRIPTION OF PREFERRED EMBODIMENTS

Hereinafter, multiple embodiments of the present invention will be explained with reference to the drawings.

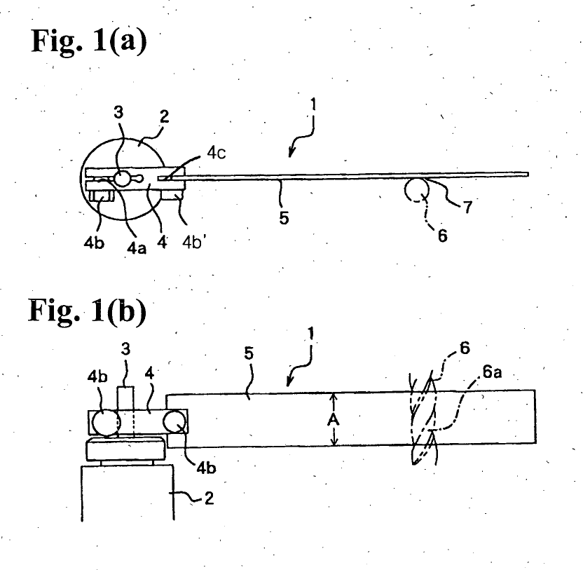

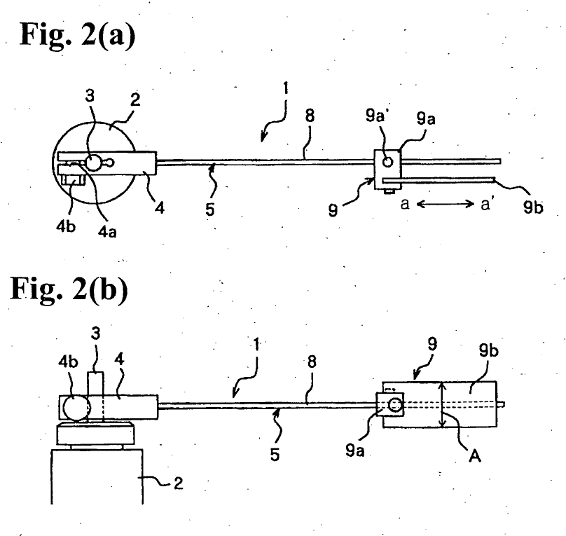

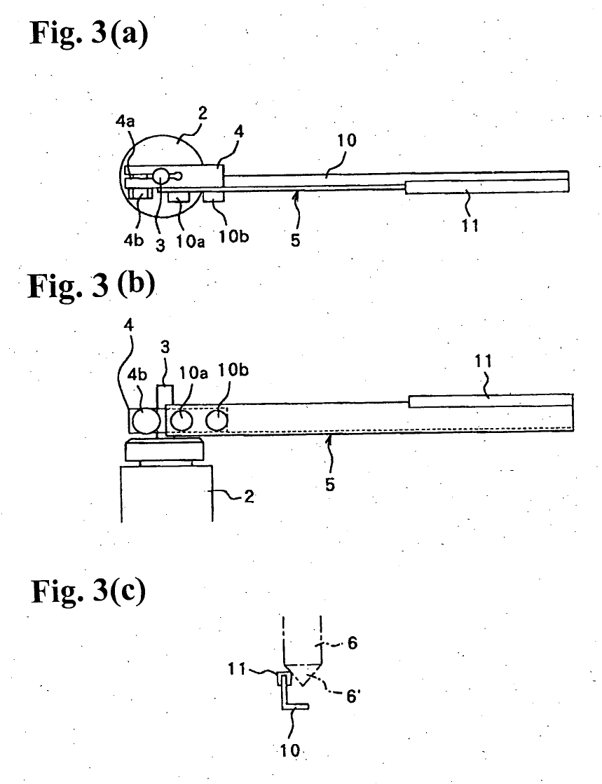

FIGS. 1(a) and 1(b) show a device 1 according to a first embodiment of the present invention. FIG. 1(a) is a plan view of the device, and FIG. 1(b) is a front view. FIGS. 2(a) and 2(b) show a device 1 according to a second embodiment of the invention. FIG. 2(a) is a plan view of the device, and FIG. 2(b) is a front view. FIGS. 3(a), 3(b), and 3(c) show a device 1 according to a third embodiment of the invention. FIG. 3(a) is a plan view of the device, FIG. 3(b) is a front view, and FIG. 3(c) is an end view.

FIGS. 1(a) and 1(b) show a device 1 according to a first embodiment of the present invention. In the device 1, a contact rod 5 consisting of a beltlike hardening leaf spring is fixed to a main axis 3 of a driving member 2 through a base end member 4, and contacts in a flattened shape against a tool 6 which resides within the scope of the rotation.

As shown in FIG. 1(b), the contact rod 5 consisting of the beltlike hardening leaf spring has a width A spanning a spiral flute 6a of a drill (tool 6) trying to detect damage over the entire length of the contact rod 5, not only for an abutting part 7. The reason why the contact rod 5 is beltlike with the width A crossing the groove is to prevent from falling into the groove or blade of the tool. Also, the reason why the contact rod 5 is made by the hardening leaf spring is to be able to escape due to the spring characteristic even if the contact rod 5 hits against the groove or blade of a rotating tool.

The base end member 4 of the contact rod 5 consisting of the beltlike hardening leaf spring includes a slotted groove 4a wherein the main axis 3 of the driving member 2 is sandwiched in the end portion of the base end member 4. The base end member 4 is fixed and tightened by clinchers 4b penetrating into the slotted groove 4a from the side face. Also, the contact rod 5 consisting of the beltlike hardening leaf spring is placed in a slotted groove 4c of the base end member 4 and is united, fixed, and tightened thereto by the clinchers 4b′.

An electric motor (controlled motor) may be used as a drive source for the driving member 2. Also, a direct-acting air drive source which is communicated from an air compressor through an air hose may be used. Like a machine tool, the direct-acting air drive source avoids electrical problems even under situations where cutting fluid (oil) drops in large quantity, or in an atmosphere full of the cutting fluid, like a mist. In this way, the direct-acting air drive source is effective.

The contact rod 5 consisting of the beltlike hardening leaf spring has a width A crossing the spiral flute 6a such as that of a drill bit over the entire length of the contact rod 5 including the abutting part 7. As shown by the dot-dash lead lines in FIG. 1(b), the contact rod 5 can regulate a fall into the spiral flute 6a. Needless to say, the regulating effect for the fall into the spiral flute 6a can effectively function even during a rotation of the tool 6.

FIGS. 2(a) and 2(b) show a device 1 according to a second embodiment of the present invention. According to the drawings, a wire needle 8 and a small contact rod 9 are provided. The wire needle 8 is fixed to the main axis 3 of the driving member 2 through the base end member 4. The small contact rod 9 consisting of the beltlike hardening leaf spring is provided in the intermediate part of the wire needle 8 to be attachable and removable, or movable to a position.

As shown in FIG. 2(a), the small contact rod 9 includes: a stationary part 9a able to be fixed and tightened to the wire needle 8; and a beltlike hardening leaf spring 9b united with the stationary part 9a by a tightening tool. As shown in FIG. 2(b), the beltlike hardening leaf spring 9b of the small contact rod 9 has the width A crossing the spiral flute 6a of the tool 6.

If a tightening tool 9a′ is loosened, the small contact rod 9 can be moved in the direction of an arrow a-a′ along the wire needle 8 with the stationary part 9a, and can be re-fixed at the most appropriate position which is determined after the movement. This is effective in order to not provide an excessive contact force to a thin tool. Also, the small contact rod 9 can be taken out of the wire needle 8 with the stationary part 9a by loosening the tightening tool 9a′ responding to a rotational direction of the tool. Accordingly, the mounting direction of the small contact rod 9 can be changed.

In addition, in the case of the device 1 of the invention shown in FIGS. 2(a) and 2(b), in common with FIGS. 1(a) and 1(b), the base end member 4 of the wire needle 8 also includes the slotted groove 4a for sandwiching the main axis 3 of the driving member 2 in the end portion of the base end member 4. Also, the base end member 4 of the wire needle 8 is fixed and tightened by the clinchers 4b penetrating into the slotted groove 4a from the side face.

FIGS. 3(a), 3(b), and 3(c) show a device 1 according to a third embodiment of the present invention. According to the drawings, as shown in FIG. 3(a), the contact rod 5 fixed to the main axis 3 of the driving member 2 through the base end member 4 is a steel-plated rod 10 whose cross-sectional surface is an L shape, and prevents flexure in an axial direction on the edge side of the tool. The third embodiment is made in such a way that the upper end face of the upper border on the edge side hits against the cut inclined face of the edge of the drill (tool 6) so that a judgment of acceptability of the chipping amount of the cut edge can be possible.

The steel-plated rod 10 whose L-shaped base end inner angle face is fitted in the lower side angle part of the base end member 4 is fixed and tightened by the clinchers 4b penetrating into the slotted groove 4a sandwiched the main axis 3. As shown in FIGS. 3(a) and 3(b), the steel-plated rod 10 is fixed by mounting tools 10a, 10b.

As shown in FIG. 3(c), at the end part of the steel-plated rod 10, a contact 11 detecting damage of an edge cut 6′ of the tool 6 is provided. The reason why the contact 11 is provided is that when the contact 11 is not abutted against the edge cut 6′ of the tool 6, the contact 11 determines “damage,” and outputs a damage signal to a control member (not shown in the figure). When the contact 11 is abutted against the edge cut 6′ of the tool 6, the contact 11 determines the condition to be “normal,” and outputs a normal signal to the control member.

Hereinafter, the operation of the device 1 of the invention will be explained. First, since the contact rod 5 of the device 1 of the invention is the beltlike hardening leaf spring with the width crossing the spiral flute of the tool 6 such as the drill or tap, even if the tool 6 is in the middle of the rotation, the contact rod 5 can detect the damage of the tool without falling into the spiral flute 6a. As a result, the operating rate of the machine will never be reduced.

Also, for the contact rod 5 of the device 1 of the invention (i.e., according to the second embodiment of the invention), when the small contact rod 9 consisting of the short beltlike hardening leaf spring with the width crossing the spiral flute 6a of the tool 6 is provided in the intermediate part of the wire needle 8 to be attachable and removable, or movable the position, the small contact rod 9 can avoid providing excessive contact force to the thin tool. Also, the small contact rod 9 can change its mounting direction in response to the rotational direction of the tool.

In addition, if the steel-plated rod whose cross-sectional surface is bent in an L shape, which is capable of preventing flexure in an axial direction on the edge side of the tool is used for the contact rod 5 (i.e., according to the third embodiment of the invention), and if the contact (edge part) on the edge side of the L-shaped contact rod is made to hit against the cut inclined face of the edge (such as with a drill bit), an accurate judgment of acceptability of the chipping amount of the cut edge of the tool 6 is possible.

The device 1 of the invention can detect breakage of the tool, or damage to the edge of the tool, without stopping the rotation of the tool. Specifically, device 1 is useful because the operating rate of the machine need not be reduced for detecting damage to the tool, or for judging the acceptability of the chipping amount.

While the invention has been described with reference to the specific embodiments thereof, the description is illustrative, and the scope of the present invention is limited only by the appended claims.

The disclosure of Japanese Patent Application No. 2005-221749 filed on Jul. 29, 2005, is incorporated herein.

What is claimed is:

1. A tool damage detection device comprising:
a contact rod for abutting against a side face of a tool at a right angle, said contact rod being formed of a beltlike hardening leaf spring with a width capable of spanning a spiral flute in said tool.

2. A tool damage detection device according to claim 1, wherein said leaf spring width is oriented parallel to an axis of rotation of said tool.

3. A tool damage detection device according to claim 1, further comprising a wire needle to be connected to the beltlike hardening leaf spring, said leaf spring capable of being attached to and removed from said wire needle, and of being adjusted to various positions relative to said tool.

4. A tool damage detection device according to claim 1, further comprising a base end member having a first slotted groove for receiving a main axis of a driving member, and a second slotted groove for receiving the contact rod, and tightening devices for tightening the respective first and second slotted grooves.

5. A tool damage detection device comprising:
a contact rod for abutting against a side face of a tool at a right angle, said contact rod being formed of a steel-plated rod with an L-shaped cross-sectional shape capable of avoiding flexure in an axial direction on an edge side of said tool; and
a contact for contacting a cut inclined face of said edge of said tool, said contact being provided on an edge side of said L-shaped contact rod.

6. A tool damage detection device comprising:
a contact rod for contacting a side face of a rotating tool piece;
a proximal end member for holding a proximal end of said contact rod; and
a driving member for rotating said proximal end member and said contact rod, wherein
said contact rod is a beltlike hardening leaf spring,
a length dimension of said contact rod is oriented perpendicular to an axis of rotation of said rotating tool piece,
a distal end width of said contact member is oriented parallel to said axis of rotation of said rotating tool piece, and
said distal end width is capable of spanning a spiral flute in said rotating tool piece.
